(19) United States
(12) Patent Application Publication
(10) Pub. No.: US 2008/0087373 A1
(43) Pub. Date: Apr. 17, 2008

(54) Polymer polyol-containing polyurethane pultrusion formulations and processes

(76) Inventors: John E. Hayes, Gibsonia, PA (US); Nigel Barksby, Moon Township, PA (US); Albert Magnotta, Monaca, PA (US)

Correspondence Address: BAYER MATERIAL SCIENCE LLC, 100 BAYER ROAD, PITTSBURGH, PA, 15205, US

(21) Appl. No.: 11/546,606

(22) Filed: Oct. 12, 2006

(51) Int. Cl. B29C 70/52

(52) U.S. Cl. 156/180; 264/137

(57) ABSTRACT

The present invention provides a reaction system for the preparation of a fiber reinforced composite according to the pultrusion process made from continuous fiber reinforcing material and a polyurethane formulation made from a polyisocyanate component containing at least one polyisocyanate and an isocyanate-reactive component containing at least one polymer polyol (“PMPO”). The inventive polyurethane formulations and improved pultrusion processes offer better processing and may yield better reinforced composites.

### FIELD OF THE INVENTION

The present invention relates in general to, pultrusion and more specifically to, polyurethane formulations containing polymer polyols for use in pultrusion processes.

### BACKGROUND OF THE INVENTION

Pultrusion is a manufacturing process for producing continuous lengths of fiber reinforced plastic (“FRP”) structural shapes. Raw materials include a liquid resin mixture (containing resin, fillers and specialized additives) and reinforcing fibers. The process involves pulling these raw materials, rather than pushing as is the case in extrusion, through a heated steel forming die using a continuous pulling device. The reinforcement materials are in continuous forms such as rolls of fiberglass mat or doffs of fiberglass roving. The two ways to impregnate, or “wet out”, the glass are open bath process and resin injection. Typical commercial resins include polyester, vinyl esters, phenolics, and epoxy compounds. These resins usually have very long gel times and can be run in an open bath process wherein the reinforcing fibers are soaked in a bath of resin and the excess resin is scraped off by a series of preform plates and at the die entrance. As the wetted fibers enter the die, the excess resin is squeezed through and off the reinforcing fibers. The pressure rise in the die inlet helps to enhance fiber wet-out and suppresses void formation. As the saturated reinforcements are pulled through the die, the gelation (or hardening) of the resin is initiated by the heat from the die and a rigid, cured profile is formed that corresponds to the shape of the die.

For resin systems like polyurethanes, which have a fast gel time and a short pot life the resin injection process is used. In the injection process, the reinforcement materials are passed through a small closed box which is usually attached to the die or may be part of the die. The resin is injected under pressure through ports in the box to impregnate the reinforcement materials. Resin injection boxes are designed to minimize resin volume and resin residence time inside the box. There are a number of different resin injection box designs in the literature all of which have the common features of an angled or tapered design and the exit profile matching the shape of the die entrance.

The patent art provides a number of teachings with respect to polyurethane pultrusion. For example, U.S. Pat. No. 6,420,493, issued to Ryckis-Kite et al., discloses a two component chemically thermoset composite resin matrix for use in composite manufacturing processes. The polyisocyanate component and the polyol component are in relative proportions in accordance with an OH/NCO equivalent ratio of 1:1 to 1:2. Ryckis-Kite et al. require the presence of 10%-40% of a polyester polyol with the use of 5 to 20 wt % of a hydroxyl terminated vegetable oil also being taught. For the isocyanate component, Ryckis-Kite et al. state that it is preferred to have at least 15 wt % of an aliphatic polyisocyanate.

Cheolas et al., in U.S. Pat. No. 6,793,855, teach polyisocyanurate systems, pultrusion of those systems to produce reinforced polyisocyanurate matrix composites and the composites produced by that pultrusion. The polyisocyanurate systems of Cheolas et al. include a polyol component, an optional chain extender, and an isocyanate. The polyisocyanurate systems are said to have extended initiation times of about 5 minutes to about 30 minutes at room temperature and to be capable of snap curing. The teaching of Cheolas et al. is that substantial polymerization of the polyurethane takes place in the impregnation die.

U.S. Pat. No. 7,056,976, in the name of Joshi et al., also discloses polyisocyanate-based reaction systems, a pultrusion process using those systems to produce reinforced matrix composites and composites produced by that pultrusion process. The polyisocyanate-based systems are mixed activated reaction systems that include a polyol composition, an optional chain extender or crosslinker and a polyisocyanate. The polyisocyanate-based systems are said to exhibit improved processing characteristics in the manufacture of fiber reinforced thermoset composites via reactive pultrusion. Joshi et al. teach that gel times are the key parameter in polyurethane pultrusion.

In addition, Cheolas et al., in U.S. Published Patent Application No. 2004/0094859 A1, teach polyisocyanurate systems, pultrusion of those systems to produce reinforced polyisocyanurate matrix composites and composites produced by that pultrusion process. The polyisocyanurate systems include a polyol component, an optional chain extender and an isocyanate. The polyisocyanurate systems are said to have extended initiation times of about 5 minutes to about 30 minutes at room temperature, and to be capable of snap curing. Cheolas et al., like Joshi et al., teach that gel times are the key parameter in polyurethane pultrusion processes.

Oftentimes, pultruders will add fillers, such as clays or low profile additives (“LPA”s), to pultrusion formulations to improve the surface finish and reduce glass content. However, the use of fillers and LPAs is disadvantageous in that such compounds do not form stable suspensions, are prone to settling or floating in the resin mixture and therefore require constant mixing. Also, fillers are prone to absorbing water which can interfere with the urethane reaction. Furthermore, most fillers have a high density and therefore high levels on a weight percent basis are required to effect small changes on a volume percent. Such high levels can lead to extremely high viscosities of the resin mix which can make processing difficult or impossible.

Therefore, a need exists in the art for improved polyurethane formulations for use in pultrusion processes to provide better processing and yield better reinforced composites.

### SUMMARY OF THE INVENTION

Accordingly, the present invention provides a reaction system for the preparation of a fiber reinforced composite according to the pultrusion process made from continuous fiber reinforcing material and a polyurethane formulation containing a polyisocyanate component including at least one polyisocyanate and an isocyanate-reactive component including at least one polymer polyol (“PMPO”). Also provided are improved pultrusion processes including the inventive polyurethane formulations that offer better processing and may yield better reinforced composites.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a reaction system for the preparation of a fiber reinforced composite according to the pultrusion process made from continuous fiber reinforcing material and a polyurethane formulation containing a polyisocyanate component including at least one polyisocyanate and an isocyanate-reactive component including at least one polymer polyol (“PMPO”).

The present invention further provides a pultrusion process for preparing a fiber reinforced polyurethane composite, the process involving continuously pulling a roving or tow of continuous fiber reinforcing material successively through an impregnation chamber and a die, continuously feeding a polyurethane formulation made from a polyisocyanate component containing at least one polyisocyanate and an isocyanate-reactive component containing at least one polymer polyol (“PMPO”) to the impregnation chamber, contacting the fiber reinforcing material with the polyurethane formulation in the impregnation chamber such that substantially complete wetting of the material by the polyurethane formulation occurs; directing the fiber reinforcing material through a die heated to reaction temperature to form a solid composite and drawing the composite from the die.

The present inventors have found that the inclusion of polymer polyols (“PMPO”s) in the polyol component in polyurethane pultrusion formulations has unexpected benefits. Polymer polyols (“PMPO”s) advantageously are stable dispersions of polymer particles in a polyol and thus are not prone to settling or floating. The polymer particles are chemically grafted to the polyol and act as a better reinforcing filler so that the composition of the polymer may be adjusted to give desired properties. Polymer polyols have a very low moisture content and thus avoid the problems of “wet” fillers. The polymers in polymer polyols generally have a low density in comparison to common pultrusion fillers such as clays or calcium carbonate. This means that on an equivalent weight percentage, the polymer polyols provide a higher volume fraction. Thus, lower levels of polymer polyols are required to effect a change in properties because polymer polyols can replace the typically more dense resin materials that make up the matrix. In some embodiments of the present invention it may even be desirable to add a conventional filler along with the polymer polyol(s) because the polymer polyol(s) may help keep the fillers in suspension.

Possible types of polymer polyols include those based on styrene acrylonitrile (“SAN”) copolymers, PHD-based on condensation of amines and isocyanates, and PIPA based on condensation of alcohol amines with isocyanates. Dispersions based on other monomers are also possible and make it possible to tailor the polymer to act as a low profile additive or fire retardant, etc. by adjusting the composition of the polymer. Dispersions of solids in the polyisocyanate component are also possible.

The polymer polyol may be the sole isocyanate-reactive component or may be blended with other polyols. The solids content may vary from preferably 0.5 wt. % to 60 wt. %, more preferably from 1 wt. % to 50 wt. %, and most preferably from 2 wt. % to 40 wt. %. It is preferred to prepare the PMPO with as high of a solids content as possible and dilute with additional polyols before use. The polyol(s) used to blend the PMPO may or may not be the same as the base polyol used to prepare the PMPO. Often it is preferred to use a blend of several polyols. The PMPO may also be a blend of different polymer polyols. The polyol(s) should have a number averaged functionality of organically bound primary or secondary alcohol groups of at least 1.8. In the present invention, the number averaged functionality of the polyol is preferably from 1.8 to 10, more preferably from 1.9 to 8 and most preferably from 2 to 6. More preferably, the isocyanate-reactive component contains predominantly, on a weight basis, a mixture of polyols with the PMPO.

In practicing some embodiments of the invention, the isocyanate-reactive component preferably contains a mixture of two or more organic polyols. The individual polyols in the mixture preferably differ principally in regard to hydroxyl group functionality and molecular weight. In particularly preferred embodiments of the present invention, the organic polyols used in the isocyanate-reactive component are chosen from softblock polyols, rigid polyols, chain extenders, crosslinkers, and combinations of these different types of polyols.

Polyols, which furnish softblock segments, are known to those skilled in the art as “softblock” polyols, or as flexible polyols. Such polyols preferably have a number averaged molecular weight of at least 1.500 Da, more preferably from 1,750 to 8,000, a number averaged equivalent weight of preferably from 400 to 4,000, more preferably from 750 to 2,500, and number averaged functionality of isocyanate reactive organic —OH groups preferably of 1.8 to 10 and more preferably from 2 to 4. Such compounds include, for example, aliphatic polyether or aliphatic polyester polyols comprising primary and/or secondary hydroxyl groups. In the practice of the present invention, it is preferred that such softblock polyols make up from 0 to 40% by weight and more preferably from 10 to 30% by weight of the isocyanate-reactive component. Preferred softblock polyols are liquids at 25° C.

A preferred class of polyols that provide structural rigidity in the derived polymer are referred to in the art as rigid polyols. Such polyols preferably have number averaged molecular weights of from 250 to 3,000, more preferably from 250 to less than 1,500; number averaged equivalent weights of preferably from 80 to 750, more preferably from 85 to 300; and number averaged isocyanate reactive group functionalities of preferably from 2 to 10, more preferably 2 to 4, and most preferably 2 to 3. Such compounds include, for example, polyether or polyester polyols comprising primary and/or secondary hydroxyl groups. Preferred rigid polyols are also liquids at 25° C.

Polyols that are referred to in the art as chain extenders and/or crosslinkers are another preferred class for inclusion in the inventive formulations and processes. These have molecular weights preferably from 60 to less than 250, more preferably from 60 to 150, equivalent weights preferably from 30 to less than 100, more preferably 30 to 70, and isocyanate-reactive group functionalities of preferably from 2 to 4, and more preferably from 2 to 3.

Examples of suitable chain-extenders/crosslinkers are simple glycols and triols, such as ethylene glycol, propylene glycol, dipropylene glycol, 1,4-butanediol, 1,3-butanediol, triethanolamine, triisopropanolamine, tripropylene glycol, diethylene glycol, triethylene glycol, glycerol, mixtures of these, and the like. The most preferred chain-extenders/crosslinkers are liquids at 25° C. Although aliphatic-OH functional compounds, such as those just listed, are the most preferred as chain-extenders/crosslinkers, it is within the scope of the present invention to employ certain polyamines, polyamine derivatives, and/or polyphenols. Examples of suitable amines known in the art include diisopropanolamine, diethanolamine, and 3,5-diethyl-2,4-diaminotoluene, 3,5-diethyl-2,6-diaminotoluene, mixtures of these, and the like. Examples of suitable isocyanate reactive amine derivatives include certain imino-functional compounds such as those described in EP 0 284 253 and EP 0 359 456 and certain enamino-functional compounds such as those described in EP 0 359 456 having 2 or more isocyanate-reactive groups per molecule. Reactive amines, especially aliphatic primary amines, are less preferred due to their extremely high reactivity with polyisocyanates, but may optionally be used if desired in minor amounts.

It is also within the scope of the present invention, albeit less preferred, to include within the isocyanate-reactive component minor amounts of other types of isocyanate reactive species that may not conform to the types described hereinabove.

In one embodiment, a preferred isocyanate-reactive component contains a mixture of polyols and PMPO wherein the hydroxyl number is preferably between 100 and 1,000, more preferably between 150 and 900, and most preferably between 200 and 800.

Some preferred types of polyols include polyether polyols and polyester polyols. Suitable polyether polyols that can be employed in the reaction systems of the invention include those that are prepared by reacting an alkylene oxide, a halogen substituted or aromatic substituted alkylene oxide or mixtures thereof, with an active hydrogen containing initiator compound.

Among the benefits of the inventive formulations are: (1) the pultruded parts have a smoother surface in some embodiments, which prevents defects from arising on the finished surface, especially those parts having complex profiles; (2) the composite parts also possess other desirable qualities, such as decreased density and weight; (3) the polymer polyols stay suspended in the isocyanate-reactive component better than added fillers; and (4) polymer polyols do not introduce unwanted water which can cause foaming.

Further, in contradistinction to the teaching in the art, exemplified by the patents mentioned hereinabove that require a high degree of polymerization occur within the impregnation die, the present inventors find it desirable to have essentially no reaction occur inside of the impregnation die. Although the gel time of all resins, not just polyurethanes, is important, the inventors herein have determined that it is not the key factor in determining pultrusion processability.

A long fiber based reinforcing material is necessary to provide mechanical strength to the pultruded composite, and to allow the transmission of the pulling force in the process. Fibers should preferably be at least long enough to pass though both the impregnation and curing dies and attach to a source of tension. In the present invention, the fibrous reinforcing material may be made of any fibrous material or materials that can provide long fibers capable of being at least partially wetted by the polyurethane formulation during impregnation. The fibrous reinforcing material may be single strands, braided strands, woven or non-woven mat structures and combinations thereof. Mats or veils made of long fibers may be used, in single ply or multi-ply structures. Suitable fibrous materials are known in the pultrusion art, include, but are not limited to, glass fibers, glass mats, carbon fibers, polyester fibers, natural fibers, aramid fibers, nylon fibers, basalt fibers, and combinations thereof. Particularly preferred in the present invention are long glass fibers. The fibers and/or fibrous reinforcing structures may be formed continuously from one or more reels feeding into the pultrusion apparatus and attached to a source of pulling force at the outlet side of the curing die. The reinforcing fibers may optionally be pre-treated with sizing agents or adhesion promoters known to those skilled in the art.

The weight percentage of the long fiber reinforcement in the pultruded composites of the present invention may vary considerably, depending on the end use application intended for the composite articles. Reinforcement loadings may be from 30 to 95% by weight, preferably from 40 to 90% by weight of the final composite, more preferably from 60 to 90% by weight, and most preferably from 70 to 90% by weight, based on the weight of the final composite. The long fiber reinforcement may be present in the pultruded composites of the present invention in an amount ranging between any combination of these values, inclusive of the recited values.

In some embodiments of the present invention, the polyisocyanate component and the isocyanate-reactive component may be the only components that are fed into the impregnation die in the pultrusion process. The polyisocyanate component or the isocyanate-reactive component may be premixed with any optional additives. However, it is to be understood that the optional additives that are not themselves polyfunctional isocyanate-reactive materials are to be considered (counted) as entities separate from the isocyanate-reactive component, even when mixed therewith. Likewise, if the optional additives, or any part thereof, are premixed with the polyisocyanate component, these are to be considered as entities separate from the polyisocyanate component, except in the case where they are themselves polyfunctional isocyanate species.

The impregnation die preferably provides for adequate mixing of the reactive components and adequate impregnation of the fibrous reinforcing material. The impregnation die may preferably be fitted with a mixing apparatus, such as a static mixer, which provides for mixing of the reactive components before the resulting reaction mixture is used to impregnate the fibrous reinforcing structure. Other types of optional mixing devices known to those skilled in the art include, but are not limited to, high-pressure impingement mixing devices or low pressure dynamic mixers such as rotating paddles. In some cases, adequate mixing may be provided in the impregnation die itself, without any additional mixing apparatus.

The pultrusion apparatus preferably has at least one impregnation die and at least one curing die. Because no polymerization is to take place in the impregnation die, the curing die necessarily will operate at a higher temperature than the impregnation die. The pultrusion apparatus may optionally contain a plurality of curing dies, or zones. Different curing zones may be set at different temperatures, if desired, but all the zones of the curing die will be higher in temperature than the impregnation die. The pultrusion apparatus may optionally contain a plurality of impregnation dies. Preferably, there is just one impregnation die, and this preferably is situated immediately prior to the first curing die (or zone). As mentioned hereinabove, the impregnation die is set at a temperature that provides for substantially no reaction (polymerization) between the polyisocyanate component and the polyisocyanate-reactive component in the polyurethane-forming formulation before the fibrous reinforcing structure, which has been at least partially impregnated with the polyurethane-forming formulation, enters the first curing die (or zone).

Polyol polymer dispersions that are useful in the present invention include, but are not limited to, the PHD and PIPA polymer modified polyols as well as the styrene-acrlyonitrile (SAN) polymer polyols. A PHD polyol contains a dispersion of a polyurea in the polyether polyol, formed in situ by polymerization of a diamine and an isocyanate, while a PIPA (polyisocyanate polyaddition) polyol contains a polymer dispersion formed by reaction of an alkanolamine with an isocyanate. In theory, any base polyol known in the art may be suitable for production of polymer polyol dispersions.

SAN polymer polyols are typically prepared by the in situ polymerization of one or more vinyl monomers, preferably acrylonitrile and styrene, in a polyol, preferably, a poly(oxyalkylene) polyol, having a minor amount of natural or induced unsaturation. Methods for preparing SAN polymer polyols are described in, for example, U.S. Pat. Nos. 3,304,273; 3,383,351; 3,523,093; 3,652,639; 3,823,201; 4,104,236; 4,111,865; 4,119,586; 4,125,505; 4,148,840 and 4,172,825; 4,524,157; 4,690,956; RE 28,715; and RE 29,118. SAN polymer polyols useful in the present invention preferably have a polymer solids content within the range of from 3 to 70 wt. %, more preferably, from 5 to 60 wt. %, based on the total weight of the SAN polymer polyol. Where used, the ratio of styrene to acrylonitrile polymerized in situ in the polyol is typically in the range of from 100:0 to 0:100 parts by weight, based on the total weight of the styrene/acrylonitrile mixture, and preferably from 80:20 to 0:100 parts by weight.

PHD polymer modified polyols are usually prepared by the in situ polymerization of an isocyanate mixture with a diamine and/or hydrazine in a polyol, preferably, a polyether polyol. Methods for preparing PHD polymer polyols are described in, for example, U.S. Pat. Nos. 4,089,835 and 4,260,530. PIPA polymer modified polyols are usually prepared by the in situ polymerization of an isocyanate mixture with a glycol and/or glycol amine in a polyol.

PHD and PIPA polymer modified polyols useful in the present invention preferably have a polymer solids content within the range of from 3 to 30 wt. %, more preferably, from 5 to 25 wt. %, based on the total weight of the PHD or PIPA polymer modified polyol. PHD and PIPA polymer modified polyols useful in the present invention preferably have hydroxyl values within the range of from 15 to 50, more preferably, from 20 to 40. Polyols used to prepare the PHD and PIPA polymer polyols of the present invention are preferably triols based on propylene oxide, ethylene oxide or mixtures thereof.

Suitable polyisocyanates are known to those skilled in the art and include unmodified isocyanates, modified polyisocyanates, and isocyanate prepolymers. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula,

Q(NCO)ₙ

in which n is a number from 2-5, preferably 2-3, and Q is an aliphatic hydrocarbon group containing 2-18, preferably 6-10, carbon atoms; a cycloaliphatic hydrocarbon group containing 4-15, preferably 5-10, carbon atoms; an araliphatic hydrocarbon group containing 8-15, preferably 8-13, carbon atoms; or an aromatic hydrocarbon group containing 6-15, preferably 6-13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate; e.g. German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654,106; polyisocyanates containing ester groups of the type described, for example, in GB 965,474 and GB 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. Those skilled in the art will recognize that it is also possible to use mixtures of the polyisocyanates described above.

Isocyanate-terminated prepolymers may also be employed in the present invention. Prepolymers may be prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known to those skilled in the art. The use of any one specific active hydrogen compound is not critical; any such compound can be employed in the practice of the present invention.

The polyisocyanate component preferably contains organic polyisocyanates having a number averaged isocyanate (NCO) functionality of from at least 1.8 to 4.0, more preferably from 2.0 to 3.0, most preferably from 2.3 to 2.9. The NCO functionality of the polyisocyanate component may be in an amount ranging between any combination of these values, inclusive of the recited values. The polyisocyanate component preferably has a free isocyanate group content (NCO content) in the range of from 5% to 50% by weight, more preferably from 8% to 40%, most preferably from 9% to 35% by weight. The NCO content of the polyisocyanate component may be in an amount ranging between any combination of these values, inclusive of the recited values.

The reaction mixture may optionally contain a catalyst for one or more of the polymer forming reactions of polyisocyanates. Catalyst(s), where used, is/are preferably introduced into the reaction mixture by pre-mixing with the isocyanate-reactive component. Catalysts for the polymer forming reactions of organic polyisocyanates are well known to those skilled in the art. Preferred catalysts include, but are not limited to, tertiary amines, tertiary amine acid salts, organic metal salts, covalently bound organometallic compounds, and combinations thereof. The levels of the preferred catalysts required to achieve the needed reactivity profile for pultrusion processing will vary with the composition of the formulation and must be optimized for each reaction system (formulation). Such optimization would be well understood by persons of ordinary skill in the art. The catalysts preferably have at least some degree of solubility in the isocyanate-reactive component used, and are most preferably fully soluble in that component at the use levels required.

The inventive formulation may contain other optional additives, if desired. Examples of additional optional additives include particulate or short fiber fillers, internal mold release agents, fire retardants, smoke suppressants, dyes, pigments, antistatic agents, antioxidants, UV stabilizers, minor amounts of viscosity reducing inert diluents, combinations of these, and any other known additives from the art. In some embodiments of the present invention, the additives or portions thereof may be provided to the fibers, such as by coating the fibers with the additive.

Internal mold release additives are highly preferred in pultrusion of mixing activated isocyanate-based resins systems to prevent sticking or buildup in the die. Suitable internal mold release agents may include, for example, fatty amides such as erucamide or stearamide, fatty acids such a oleic acid, oleic acid amides, fatty esters such as LOXIOL G71S inert polyester (from Henkel), carnuba wax, beeswax (natural esters), butyl stearate, octyl stearate, ethylene glycol monostearate, ethylene glycol distearate, glycerin di-oleate, glycerin tri-oleate, and esters of polycarboxylic acids with long chain aliphatic monovalent alcohols such as dioctyl sebacate, mixtures of (a) mixed esters of aliphatic polyols, dicarboxylic acids and long-chained aliphatic monocarboxylic acids, and (b) esters of the groups: (1) esters of dicarboxylic acids and long-chained aliphatic monofunctional alcohols, (2) esters of long-chained aliphatic monofunctional alcohols and long-chained aliphatic monofunctional carboxylic acids, (3) complete or partial esters of aliphatic polyols and long-chained aliphatic monocarboxylic acids, silicones such as TEGO IMR 412T silicone (from Goldschmidt), KEMESTER 5721 ester (a fatty acid ester product from Witco Corporation), fatty acid metal carboxylates such as zinc stearate and calcium stearate, waxes such as montan wax and chlorinated waxes, fluorine containing compounds such as polytetrafluoroethylene, fatty alkyl phosphates (both acidic and non acidic types such as ZELEC UN, ZELEC AN, ZELEC MR, ZELEC VM-, ZELEC UN, ZELECLA-1, and ZELEC LA-2 phosphates, which are all commercially available from Stepan Chemical Company), chlorinated-alkyl phosphates; hydrocarbon oils, combinations of these, and the like. Especially preferred internal mold release agents are TECHLUBE 550HB available from Technick Products and 1948MCH available from Axel Plastics.

Other preferred optional additives for use in pultrusion include moisture scavengers, such as molecular sieves; defoamers, such as polydimethylsiloxanes; coupling agents, such as the mono-oxirane or organo-amine functional trialkoxysilanes; combinations of these and the like. The coupling agents are particularly preferred for improving the bonding of the matrix resin to the fiber reinforcement. Fine particulate fillers, such as clays and fine silicas, are often used at thixotropic additives. Such particulate fillers may also serve as extenders to reduce resin usage. Fire retardants are sometimes desirable as additives in pultruded composites. Examples of preferred fire retardant types include, but are not limited to, triaryl phosphates; trialkyl phophates, especially those bearing halogens; melamine (as filler); melamine resins (in minor amounts); halogenated paraffins and combinations thereof.

The stoichiometry of mixing isocyanate-based polymer forming formulations, containing an organic polyisocyanate and a polyfunctional isocyanate reactive resin is often expressed by a quantity known in the art as the isocyanate index. The index of such a mixing activated formulation is simply the ratio of the total number of reactive isocyanate (—NCO) groups present to the total number of isocyanate-reactive groups (that can react with the isocyanate under the conditions employed in the process). This quantity is often multiplied by 100 and expressed as a percent. Preferred isocyanate index values in the mixing activated formulations, which are suitable for use in the invention range from 70 to 150%. A more preferred range of index values is from 90 to 125%.

As those skilled in the art are aware, pultrusion of polyurethane and polyisocyanurate systems with fiber reinforced composites is performed by supplying the isocyanate and polyol components to a mix/metering machine for delivery in a desired ratio to a mixing apparatus, preferably a static mixer, to produce a reaction mixture. The reaction mixture is supplied to an injection die where it can be used to impregnate fibers being pulled concurrently into the injection die. The resulting uncured composite is pulled through a zoned heating die, attached directly to the injection die, having a desired cross-section where it is shaped and cured. The curing die has two to three heated zones equipped with electrical heating coils individually controlled to maintain the desired temperatures. The entrance to the die is cooled to prevent premature polymerization. The temperature at the hottest zone generally ranges from about 350° F. to about 450° F. The dynamic forces needed to pull the composite through the forming die are supplied by the pulling machine. This machine typically has gripping devices that contact the cured composite profile (or the glass fibers therein) and give the traction necessary to pull the composite profile through the die. The machine also has a device that develops a force in the desired direction of pull that gives the impetus necessary to pull the composite profile continuously through the die. The resulting composite profile upon exiting the pulling machine is then cut to the desired length typically by an abrasive cut off saw.

### EXAMPLES

The present invention is further illustrated, but is not to be limited, by the following examples. All quantities given in “parts” and “percents” are understood to be by weight, unless otherwise indicated. The following materials were used in the formulations

| | |
|---|---|
| POLYOL A | an oxypropoxylated glycerol, nominal triol having a |
| | hydroxyl number of about 1050 meq/g KOH; |
| POLYOL B | an oxypropoxylated glycerol, nominal triol having a |
| | hydroxyl number of about 470 meq/g KOH; |
| POLYOL C | an oxypropoxylated glycerol, nominal triol having a |
| | hydroxyl number of about 238 meq/g KOH; |
| POLYOL D | an oxypropoxylated propylene glycol, nominal diol having |
| | a hydroxyl number of about 28 meq/g KOH, prepared using |
| | a double metal cyanide catalyst; |
| POLYOL E | an oxypropoxylated glycerol, nominal triol having a |
| | hydroxyl number of about 240 meq/g KOH, prepared using |
| | a double metal cyanide catalyst; |
| POLYOL F | an oxypropoxylated glycerol, nominal triol having a |
| | hydroxyl number of about 52 meq/g KOH; |
| MOLECULAR SIEVE | a blend of a molecular sieve in oxypropoxylated glycerol, |
| | nominal triol having a hydroxyl number of about 28 meq/g |
| | KOH; |
| RELEASE AGENT | an internal mold release agent available as TECHLUBE 550 HB |
| | from Technick Products; |
| CATALYST | a tin catalyst available as FORMREZ UL 29 from GE |
| | Silicones; |
| PMPO A | a styrene acrylonitrile copolymer polyol with a nominal |
| | solids content of 45 wt % based on POLYOL F, having a |
| | hydroxyl number of about 28 meq/g KOH; |
| PMPO B | a Styrene Acrylonitrile copolymer polyol with a nominal |
| | solids content of 49 wt % based on POLYOL E and having |
| | a hydroxyl number of about 110 meq/g KOH; and |
| ISOCYANATE | is a liquid polymeric MDI product having a free isocyanate |
| | group content of about 31.4% by weight and a number |
| | averaged isocyanate group functionality of about 2.8. |

### Examples 1 and 2

The formulations as detailed below in Table I were processed on a PTI PULSTAR 804 commercial pultrusion machine with different die profiles and were found to process well over a range of speeds and temperatures.

TABLE I

| | Ex. 1 | Ex. 2 |
|---|---|---|
| Isocyanate-reactive blend | (parts) | (parts) |
| POLYOL C | 15 | 15 |
| POLYOL B | 25 | 25 |
| POLYOL A | 25 | 25 |
| POLYOL D | 20 | 0 |
| MOLECULAR SIEVE | 4 | 4 |
| RELEASE AGENT | 4 | 4 |
| PMPO A | 0 | 20 |
| PMPO B | 30 | 0 |
| CATALYST | 0.70 | 0.5 |
| ISOCYANATE | 124 | 124 |
| Isocyanate Index | 114 | 114 |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A reaction system for the preparation of a fiber reinforced composite according to the pultrusion process comprising:
continuous fiber reinforcing material; and
a polyurethane formulation comprising,
a polyisocyanate component containing at least one polyisocyanate, and
an isocyanate-reactive component containing at least one polymer polyol (“PMPO”).

2. The reaction system according to claim 1, wherein the fiber reinforcing material is selected from the group consisting of single strands, braided strands, woven mat structures, non-woven mat structures and combinations thereof.

3. The reaction system according to claim 1, wherein the fiber reinforcing material comprises one or more of glass fibers, glass mats, carbon fibers, polyester fibers, natural fibers, aramid fibers, basalt fibers and nylon fibers.

4. The reaction system according to claim 1, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethyl-cyclohexane (“isophorone diisocyanate”), 2,4- and 2,6-hexahydrotoluene diisocyanate, dicyclohexylmethane-4,4′-diisocyanate (“hydrogenated MDI”, or “HMDI”), 1,3- and 1,4-phenylene diisocyanate, 2,4- and 2,6-toluene diisocyanate (“TDI”), diphenylmethane-2,4′- and/or -4,4′-diisocyanate (“MDI”), naphthylene-1,5-diisocyanate, triphenyl-methane-4,4′,4″-triisocyanate, polyphenyl-polymethylene-polyisocyanates (“crude MDI”), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret-containing polyisocyanates, isocyanate-terminated prepolymers and mixtures thereof.

5. The reaction system according to claim 1, wherein the at least one polymer polyol (“PMPO”) is selected from the group consisting of styrene-acrlyonitrile (“SAN”) polymer polyols, polyurea suspension (“PHD”) polymer modified polyols and polyisocyanate polyaddition (“PIPA”) polymer modified polyols.

6. The reaction system according to claim 1, wherein the isocyanate-reactive component further includes one or more softblock polyols, rigid polyols, chain extenders, crosslinkers and combinations thereof.

7. The reaction system according to claim 1, wherein the isocyanate-reactive component has a hydroxyl number of from about 100 to about 1,000.

8. A pultrusion process for preparing a fiber reinforced polyurethane composite, the process comprising:
continuously pulling a roving or tow of continuous fiber reinforcing material successively through an impregnation chamber and a die;
continuously feeding a polyurethane formulation comprising a polyisocyanate component containing at least one polyisocyanate, and an isocyanate-reactive component containing at least one polymer polyol (“PMPO”) to the impregnation chamber;
contacting the fiber reinforcing material with the mixture in the impregnation chamber such that substantially complete wetting of the material by the mixture occurs;
directing the fiber reinforcing material through a die heated to reaction temperature to form a solid composite; and
drawing the composite from the die.

9. The pultrusion process according to claim 8, wherein the fiber reinforcing material is selected from the group consisting of single strands, braided strands, woven mat structures, non-woven mat structures and combinations thereof.

10. The pultrusion process according to claim 8, wherein the fiber reinforcing material comprises one or more of glass fibers, glass mats, carbon fibers, polyester fibers, natural fibers, aramid fibers, basalt fibers and nylon fibers.

11. The pultrusion process according to claim 8, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethyl-cyclohexane (“isophorone diisocyanate”), 2,4- and 2,6-hexahydrotoluene diisocyanate, dicyclohexylmethane-4,4′-diisocyanate (“hydrogenated MDI”, or “HMDI”), 1,3- and 1,4-phenylene diisocyanate, 2,4- and 2,6-toluene diisocyanate (“TDI”), diphenylmethane-2,4′- and/or -4,4′-diisocyanate (“MDI”), naphthylene-1,5-diisocyanate, triphenyl-methane-4,4′,4″-triisocyanate, polyphenyl-polymethylene-polyisocyanates (“crude MDI”), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret-containing polyisocyanates, isocyanate-terminated prepolymers and mixtures thereof.

12. The pultrusion process according to claim 8, wherein the at least one polymer polyol (“PMPO”) is selected from the group consisting of styrene-acrlyonitrile (“SAN”) polymer polyols, polyurea suspension (“PHD”) polymer modified polyols and polyisocyanate polyaddition (“PIPA”) polymer modified polyols.

13. The pultrusion process according to claim 8, wherein the isocyanate-reactive component further includes one or more softblock polyols, rigid polyols, chain extenders, crosslinkers and combinations thereof.

14. The pultrusion process according to claim 8, wherein the isocyanate-reactive component has a hydroxyl number of from about 100 to about 1,000.
